(19) United States
(12) Patent Application Publication
(10) Pub. No.: US 2010/0271406 A1
(43) Pub. Date: Oct. 28, 2010

(54) Display driver and method of testing the same

(75) Inventor: Toshikazu Tazuke, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 12/662,066

(22) Filed: Mar. 30, 2010

(30) Foreign Application Priority Data
Apr. 22, 2009 (JP) 2009-103602

(51) Int. Cl. G09G 5/10

(52) U.S. Cl. 345/690

(57) ABSTRACT

A display driver includes a gradation data register that stores gradation data having a bit width, and a gradation voltage signal generator that generates a gradation voltage signal that has voltage according to the gradation data stored in the gradation data register and outputs the generated gradation voltage signal, the display driver further including a test circuit that is provided between the gradation data register and the gradation voltage signal generator, the test circuit connecting at least a plurality of bit lines among bit lines provided between both of the circuits through a common node in a test mode, so as to perform failure detection based on a value of current that flows in the common node.

### INCORPORATION BY REFERENCE

This application is based upon and claims the benefit of priority from Japanese patent application No. 2009-103602, filed on Apr. 22, 2009, the disclosure of which is incorporated herein in its entirety by reference.

### BACKGROUND

1. Field of the Invention

The present invention relates to a display driver and a method of testing the same.

2. Description of Related Art

In recent years, functions such as small amplitude input operation and high frequency data transfer have been required in display panel drivers (display drivers). In accordance with this, various problems such as display defects occur in customer panels due to data transfer defects or data input defects of the display drivers. To address these problems, an operation test has been performed to check whether data is correctly input to a display driver. However, in display drivers that do not include test circuits, the operation test needs to be performed based on gradation voltage, which is a result of an output from the display driver. More specifically, the operation test needs to be performed accurately for the gradation voltage of 64 gradations when the input data (gradation data) of the display driver is six bits, and 256 gradations when the input data is eight bits. In order to perform the operation test of a multi-gradation and multi-output display driver, a large-sized expensive tester is needed. Therefore, there has been a strong demand for a technique that makes it possible to detect data input defects and the like with an inexpensive tester in high speed.

FIG. 8 shows a test circuit of a display driver disclosed in Japanese Unexamined Patent Application Publication No. 10-240194. The circuit shown in FIG. 8 includes memory circuits 111, 121, 131, operational circuits 112, 122, 132, drive circuits 113, 123, 133, a control circuit 140, an address circuit 150, a positive logical AND circuit (AND circuit) 151, and a negative logical AND circuit (OR circuit) 152. The memory circuits 111, 121, 131 have the same circuit configuration. The memory circuits sequentially store gradation data input from the gradation data input terminal 101 according to the signal supplied from the address circuit 150. Each of the memory circuits concurrently outputs the gradation data stored therein by a control signal supplied from the control circuit 140 through the address circuit 150. The operational circuits 112, 122, 132 have the same circuit configuration. Signals output from the memory circuit 111, the memory circuit 121, and the memory circuit 131 are input to the operational circuits 112, 122, 132; respectively. Further, the control signal output from the control circuit 140 is input to each of the operational circuits. Each operational circuit performs the operation that is set in advance and outputs the operation result. The drive circuits 113, 123, 133 have the same circuit configuration. Signals output from the operational circuits 112, 122, and 132 are input to the drive circuits 113, 123, 133, respectively. Each of the drive circuits outputs a signal that is amplified to voltage or current suitable for driving a liquid crystal device.

As shown in FIG. 8, output signals from the drive circuits 113, 123, and 133 are input to the positive logical AND circuit 151. The positive logical AND circuit 151 outputs the result of logical AND operation of the positive logic to the output terminal 105. Meanwhile, the output signals from the drive circuits 113, 123, and 133 are input to the negative logical AND circuit 152. The negative logical AND circuit 152 outputs the result of logical AND operation of the negative logic to the output terminal 106. By observing the voltages of the output terminals 105 and 106 in the test mode, it is possible to judge whether the output result based on the gradation data (latched data) is correct or not.

FIG. 9 shows a block diagram of a display driver including a test output terminal for describing the present invention. The circuit shown in FIG. 9 includes a shift register 312, a gradation data input circuit 313, a gradation data register 314, a gradation data latch circuit 315, a test circuit 316, a level shifter 317, a gradation voltage selector 318, and an output amplifier 319. For the sake of convenience, a clock input 301, a start pulse input 302, a start pulse output 303, a gradation data input 304, a latch pulse input 305, a test input 306, a test output 307, a reference power supply input 308, a gradation voltage output 309, a high potential side power supply 310, and a low potential side power supply 311 each shows a terminal name and a signal name. Further, the circuit shown in FIG. 9 shows a case in which the gradation data input signal 304 is six bits (64 gradations).

In this example, the shift register 312 is formed by a six-stage register. The start pulse input signal 302 and the clock input signal 301 are supplied to the shift register 312. The shift pulse signal is formed by sequentially shifting the start pulse input signal 302 in synchronization with the clock input signal 301.

Furthermore, in the example shown in FIG. 9, the display driver includes six gradation data registers 314. The six-bit gradation data input signal 304 is supplied to each gradation data register 314 through the gradation data input circuit 313 in parallel. The gradation data registers 314 are sequentially selected based on the shift pulse signal that is supplied from the shift register 312, so that the gradation data is stored.

Upon completion of input of the gradation data to each of the gradation data registers 314, the latch pulse input signal 305 is input to the gradation data latch circuit 315. Thus, the gradation data latch circuit 315 concurrently latches (synchronously outputs) the gradation data held in each of the gradation data registers 314. The gradation data that is latched by the gradation data latch circuit 315 is input to the test circuit 316. In the test circuit 316, a normal operation mode and a test mode are switched by the test input signal 306. In the normal operation mode, the gradation data that is latched by the gradation data latch circuit 315 is supplied to the level shifter 317 through the test circuit 316, and the voltage level is shifted appropriately by the level shifter 317. The gradation voltage selector 318 selectively outputs any of a plurality of reference voltages V1 to Vn (n is a natural number of two or more) supplied from the reference power supply input terminal 308 based on the gradation data after performing the level shift. Then, the output amplifier 319 amplifies reference voltage selected by the gradation voltage selector 318, and outputs the amplified voltage to the gradation voltage output terminal 309. In this example, six output amplifiers 319 amplify the corresponding output signals (reference voltages) of the gradation voltage selector 318, and output the amplified signals to the gradation voltage output terminal 309.

On the other hand, in the test mode, the operation test that is similar to that shown in FIG. 8 is performed, for example. In summary, the voltage of the gradation data input to the test circuit 316 is observed. More specifically, the voltage output from the test output terminal 307 is observed. Thereby, it is possible to judge whether the gradation data output from the gradation data latch circuit 315 is correct or not by observing the voltage output from the test output terminal 307.

As described above, in the circuits shown in FIGS. 8 and 9, the voltage value which is a result of the operation test is externally output and observed. Accordingly, the test output terminal needs to be provided, and an observation circuit to observe the test result (result of the operation test; result of the failure detection) needs to be added. In short, according to the related art, the circuit size is increased. Furthermore, in the circuits shown in FIGS. 8 and 9, it is only observed in the operation test that the defect has occurred. Hence, even when there are defects in a plurality of parts, it is impossible to recognize it. Furthermore, it is impossible to specify the defective parts.

FIG. 10 shows a display driver 200 disclosed in Japanese Unexamined Patent Application Publication No. 2006-227168. The display driver 200 includes a hold circuit 210 that holds and outputs display data (gradation data), a level interface 230 that adjusts output level of the hold circuit 210, a D/A converter 220 that D/A converts the display data output from the level interface 230, a buffer 240 that outputs gradation voltage based on the output voltage of the D/A converter 220, and an output selector 250 that selects the gradation voltage (analog signal) and the display data (digital signal) and outputs the selected one to a drive voltage output terminal VOUT.

The hold circuit 210 holds n-bit display data that is input to each of input terminals LIN1 to LINn (n is a natural number of two or more) in synchronization with a clock signal DTLHCK when a scan enable signal SCANEN is set to a non-active state. Then, the hold circuit 210 outputs n-bit display data that is held therein for each bit from corresponding output terminals LQ1 to LQn. The n-bit display data that is output from the hold circuit 210 is input to the D/A converter 220 through the level interface 230. The D/A converter 220 outputs the gradation voltage according to the display data to an input terminal IN1 of the output selector 250 through the buffer 240.

On the other hand, when the scan enable signal SCANEN is set to an active state, the hold circuit 210 serially outputs the n-bit display data that is held therein from one-bit-width output terminal LQn. The serial output means outputting n-th bit data from one-bit-width output terminal LQn in synchronization with the clock signal, for example, then outputting (n−1)-th bit data from the output terminal LQn, and thereafter sequentially outputting data until the first bit data. A series of n to first bit data output by this serial output is called serial output data. The serial output data output from the output terminal LQn is input to an input terminal IN2 of the output selector 250 through the level interface 230.

In the normal operation mode, the output selector 250 selects and outputs the gradation voltage that is input to the input terminal IN1. Further, the scan enable signal SCANEN is set to a non-active state. At this time, the output selector 250 outputs the gradation voltage to the drive voltage output terminal VOUT. On the other hand, in the test mode, the output selector 250 selects and outputs the display data input to the input terminal IN2. Further, the scan enable signal SCANEN is set to the active state. At this time, the output selector 250 sequentially outputs the voltage based on the serial output data to the drive voltage output terminal VOUT. This serial output data and the test pattern of the display data which is previously set are compared by the observation circuit which is externally provided, so as to judge whether the two data are matched. Hence, the operation test can be performed to check whether the display driver 200 performs the operation as designed or the like.

In the circuit disclosed in Japanese Unexamined Patent Application Publication No. 2006-227168, the gradation data needs to be output with high voltage and in a serial manner in the test mode. Thus, complicated timing control and data processing are required. This causes longer judgment time (longer operation test). Especially, this problem can be serious when the bit width of the display data (gradation data) is increased. Further, in the operation test, the voltage value which is the result of the operation test is externally output and observed, as in a similar way as disclosed in Japanese Unexamined Patent Application Publication No. 10-240194. Hence, the test output terminal needs to be provided, and the observation circuit to observe the test result (result of the operation test; result of the failure detection) needs to be added as well. In short, according to the related art, the circuit size is increased.

In addition, in the circuit disclosed in Japanese Unexamined Patent Application Publication No. 2006-178029, operation test is performed by measuring the current value of the output terminal of the display driver. However, according to this related art, the current value as a result of performing operational processing (output signal) based on the input data (gradation data) is measured. Thus, when the input data has a bit width, it is impossible to specify in which bit line a defect occurs.

### SUMMARY

The present inventors have found a problem that, in the display driver disclosed in the related arts, circuit size is increased in detecting a failure.

An exemplary aspect of the present invention is a display driver including a gradation data register (for example, a gradation data register 14 in a first exemplary embodiment of the present invention) that stores gradation data having a bit width, and a gradation voltage signal generator (for example, a gradation voltage selector 18 in the first exemplary embodiment of the present invention) that generates a gradation voltage signal that has voltage according to the gradation data stored in the gradation data register and outputs the generated gradation voltage signal, the display driver further including a test circuit that is provided between the gradation data register and the gradation voltage signal generator, the test circuit connecting at least a plurality of bit lines among bit lines provided between both of the circuits through a common node in a test mode, so as to perform failure detection based on a value of current that flows in the common node.

According to the circuit configuration as stated above, it is possible to readily perform failure detection while suppressing the increase of the circuit size.

Another exemplary aspect of the present invention is a method of testing a display driver that generates a gradation voltage signal according to gradation data having a bit width based on the gradation data and outputs the generated gradation voltage signal, the method including connecting at least a plurality of bit lines among bit lines where the gradation data flows, the plurality of bit lines being connected through a common node, and upon inputting gradation data for testing according to the display driver, detecting whether a current value according to the gradation data for testing flows in the common node, so as to detect a failure.

According to the above-described method, it is possible to readily perform failure detection while suppressing the increase of the circuit size.

According to the present invention, it is possible to provide a display driver that makes it possible to readily perform failure detection while suppressing the increase of the circuit size.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a circuit diagram of a display driver according to a first exemplary embodiment of the present invention;

FIG. 2 is a circuit diagram of the display driver according to the first exemplary embodiment of the present invention;

FIG. 3 is a diagram showing test operation of the display driver according to the first exemplary embodiment of the present invention;

FIG. 4 is a diagram showing the test operation of the display driver according to the first exemplary embodiment of the present invention;

FIG. 5 is a diagram showing the test operation of the display driver according to the first exemplary embodiment of the present invention;

FIG. 6 is a timing chart showing the test operation of the display driver according to the first exemplary embodiment of the present invention;

FIG. 7 is a circuit diagram of a display driver according to a second exemplary embodiment of the present invention;

FIG. 8 is a circuit diagram of a display driver according to Japanese Unexamined Patent Application Publication No. 10-240194;

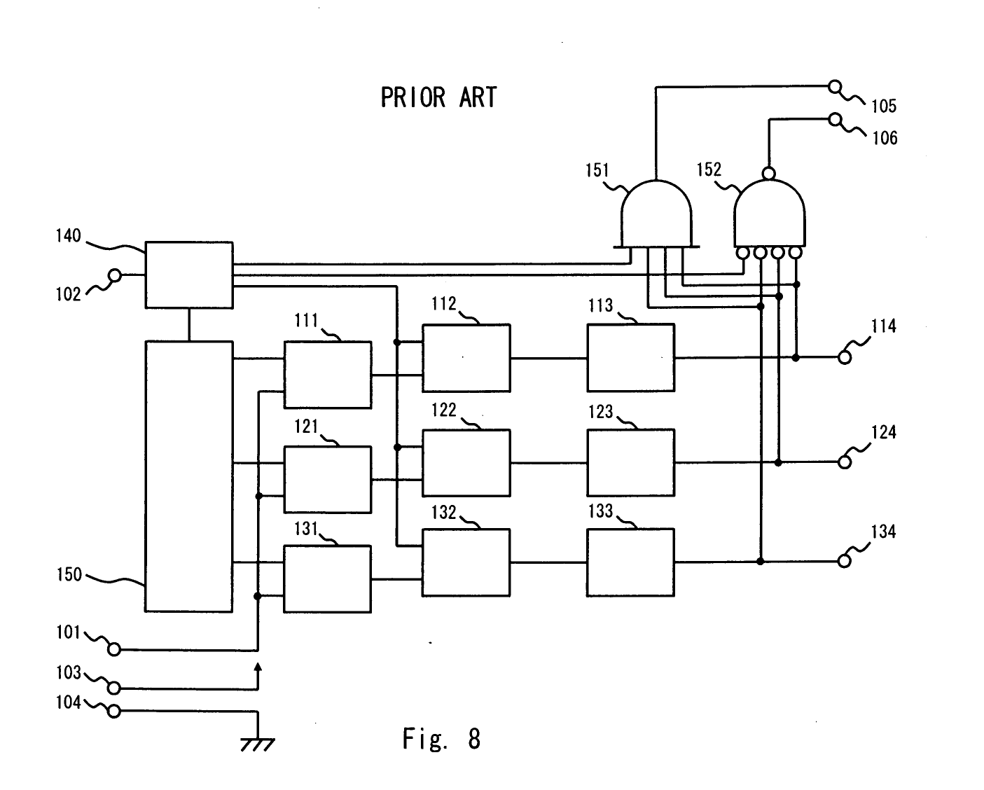

FIG. 9 is a circuit diagram of a display driver according to a related art; and

FIG. 10 is a circuit diagram of a display driver according to Japanese Unexamined Patent Application Publication No. 2006-227168.

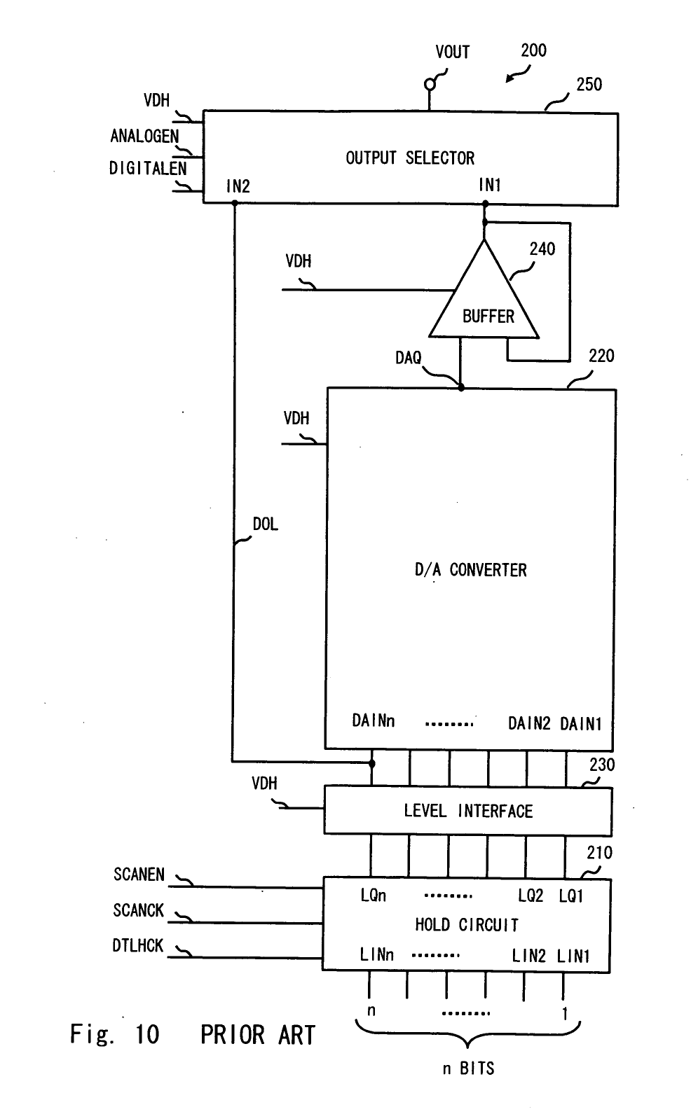

### DETAILED DESCRIPTION OF THE EXEMPLARY EMBODIMENTS

Hereinafter, the specific exemplary embodiments to which the present invention is applied will be described in detail with reference to the drawings. Throughout the drawings, the same components are denoted by the same reference symbols, and overlapping description will be omitted as appropriate for the sake of clarity.

### First Exemplary Embodiment

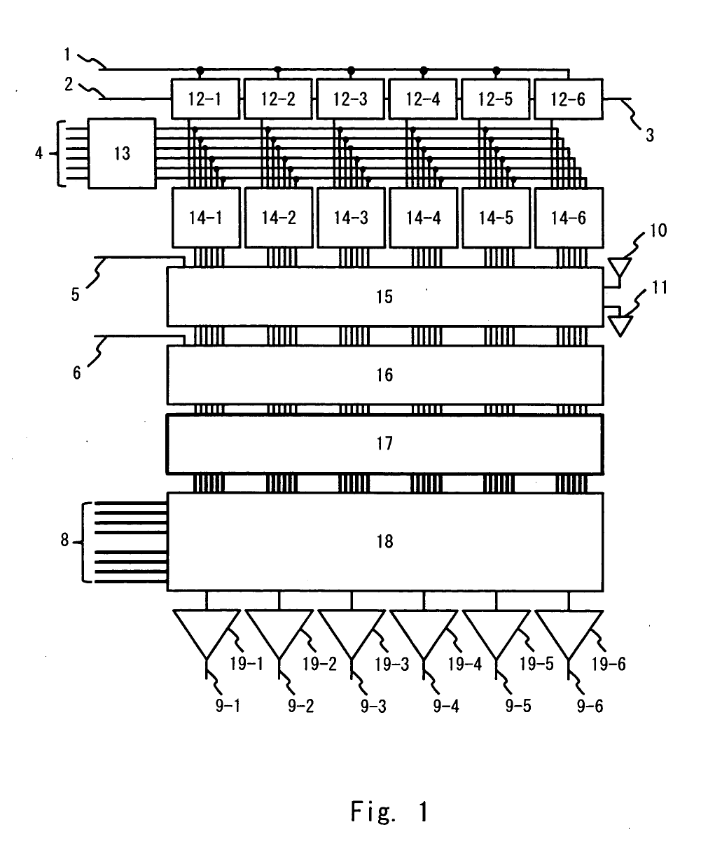

The first exemplary embodiment of the present invention will be described with reference to the drawings. FIG. 1 is a block diagram of a display driver according to the first exemplary embodiment of the present invention.

The circuit shown in FIG. 1 includes a shift register 12, a gradation data input circuit 13, a gradation data register 14, a gradation data latch circuit 15, a test circuit 16, a level shifter 17, a gradation voltage selector (gradation voltage signal generator) 18, and an output amplifier 19. For the sake of convenience, a clock input 1, a start pulse input 2, a start pulse output 3, a gradation data input 4, a latch pulse input 5, a test input 6, a reference power supply input 8, a gradation voltage output 9, a high potential side power supply 10, and a low potential side power supply 11 each shows a terminal name and a signal name.

The circuit shown in FIG. 1 shows a case in which the gradation data input signal 4 is six bits (64 gradations). Such a circuit configuration merely shows one example of the exemplary embodiment, and may be changed in various ways without departing from the spirit of the present invention. For example, although the first exemplary embodiment shows a case in which the gradation data input signal 4 is six bits, the present invention may be applied to circuit configurations having different bit widths. Further, although the first exemplary embodiment shows a case in which six gradation data registers 14 are included, the present invention may be applied to other circuit configurations in which different numbers of gradation data registers 14 are provided.

In this example, the shift register 12 is formed by a six-stage register. Further, the gradation data register 14 is formed by six gradation data registers 14-1 to 14-6. In addition, the output amplifier 19 is formed by output amplifiers 19-1 to 19-6. The six-stage register in the shift register 12 is differentiated as shift registers 12-1 to 12-6. Further, six gradation voltage output terminals 9 connected to output terminals of the output amplifier 19 are also differentiated as gradation voltage output terminals 9-1 to 9-6.

The clock input terminal 1 is connected to each of input terminals of the shift registers 12-1 to 12-6. Further, the shift registers 12-1 to 12-6 are connected in series between the start pulse input terminal 2 and the start pulse output terminal 3, so as to form the shift register. The six-bit-width gradation data input terminal 4 is connected to a six-bit-width input terminal of the gradation data input circuit 13. A six-bit-width output terminal of the gradation data input circuit 13 is connected to each of six-bit-width input terminals of the gradation data registers 14-1 to 14-6. Output terminals of the shift registers 12-1 to 12-6 are connected to other input terminals of the corresponding gradation data registers 14-1 to 14-6, respectively.

A six-bit-width output terminal of each of the gradation data registers 14-1 to 14-6 is connected to input terminals (36 bit widths=6 bits×6) of the gradation voltage selector 18 through the gradation data latch circuit 15, the test circuit 16, and the level shifter 17. The latch pulse input terminal 5 is connected to the other input terminal of the gradation data latch circuit 15. The test input terminal 6 is connected to the other input terminal of the test circuit 16. The reference power supply input terminal 8 of V1 to Vn (n is a natural number of two or more) is connected to the other input terminal of the gradation voltage selector 18. In the gradation voltage selector 18, six output terminals corresponding to the gradation data registers 14-1 to 14-6 are connected to input terminals of the corresponding output amplifiers 19-1 to 19-6. Output terminals of the output amplifiers 19-1 to 19-6 are connected to the corresponding gradation voltage output terminals 9-1 to 9-6.

The start pulse input signal 2 and the clock input signal 1 are supplied to the shift register 12. The shift register 12 forms a shift pulse signal by sequentially shifting the start pulse input signal 2 in synchronization with the clock input signal 1.

Further, six-bit gradation data input signal 4 is supplied to each of the gradation data registers 14-1 to 14-6 through the gradation data input circuit 13. Any one of the gradation data registers 14-1 to 14-6 is selected based on the shift pulse signal supplied from the shift register 12. Then, the gradation data is stored in the gradation data register that is selected. In this way, the gradation data registers 14-1 to 14-6 that store the gradation data are selectively switched based on the shift pulse signal.

Upon completion of input of the gradation data into the gradation data registers 14-1 to 14-6, the latch pulse input signal 5 is input to the gradation data latch circuit 15. Accordingly, the gradation data latch circuit 15 concurrently latches (synchronously outputs) the gradation data held in the gradation data registers 14-1 to 14-6. The gradation data that is output from the gradation data latch circuit 15 is input to the test circuit 16. Note that, in the test circuit 16, a normal operation mode and a test mode are selectively switched based on the test input signal 6.

In the normal operation mode, voltage level of the gradation data that is output from the gradation data latch circuit 15 is shifted as appropriate by the level shifter 17 through the test circuit 16. The gradation voltage selector 18 selectively outputs one of a plurality of reference voltages V1 to Vn (n is a natural number of two or more) that are supplied from the reference power supply input terminal 8 based on the gradation data after performing the level shift. Then, the output amplifier 19 amplifies the reference voltage that is selected by the gradation voltage selector 18 and outputs the amplified voltage to the gradation voltage output terminal 9. In this example, six output amplifiers 19-1 to 19-6 amplify the corresponding reference voltage selected by the gradation voltage selector 18 and output the amplified voltage to the gradation voltage output terminal 9. Although the high potential side power supply terminal 10 and the low potential side power supply terminal 11 are connected to the gradation data latch circuit 15 in FIG. 1, they are connected to power supplies of all the other circuits.

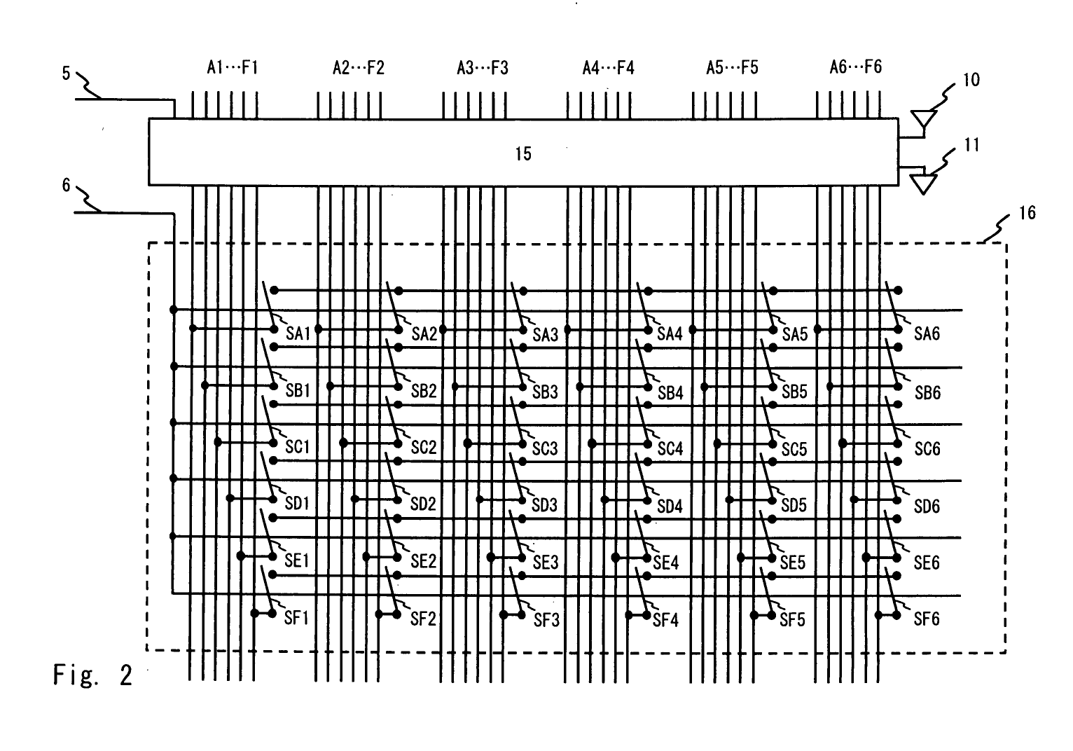

Now, FIG. 2 shows the circuit configuration of the test circuit 16 according to the first exemplary embodiment of the present invention. In the example shown in FIG. 2, each bit line of the six-bit-width gradation data output from the gradation data register 14-1 (not shown) is called A1, B1, C1, D1, E1, F1. Similarly, each bit line of the six-bit-width gradation data output from the gradation data register 14-2 (not shown) is called A2, B2, C2, D2, E2, F2. Each bit line of the six-bit-width gradation data output from the gradation data register 14-3 (not shown) is called A3, B3, C3, D3, E3, F3. Each bit line of the six-bit-width gradation data output from the gradation data register 14-4 (not shown) is called A4, B4, C4, D4, E4, F4. Each bit line of the six-bit-width gradation data output from the gradation data register 14-5 (not shown) is called A5, B5, C5, D5, E5, F5. Each bit line of the six-bit-width gradation data output from the gradation data register 14-6 (not shown) is called A6, B6, C6, D6, E6, F6. These total 36 bit lines are connected to the input terminals of the gradation data selector 18 (not shown) through the test circuit 16 and the level shifter 17.

The test circuit 16 includes switch elements corresponding to 36 bit lines. In the example shown in FIG. 2, the test circuit 16 includes 36 switch elements corresponding to 36 bit lines. One terminal of each switch element is connected to the corresponding bit line. The switch element having one terminal connected to the bit line A1 is called SA1. The switch element having one terminal connected to the bit line B1 is called SB1. Similarly, the switch elements are named by adding “S” to the top of each bit line connected to one terminal of each switch element.

The other terminals of the switch elements SA1 to SA6 are connected each other through a first common node. The other terminals of the switch elements SB1 to SB6 are connected each other through a second common node. The other terminals of the switch elements SC1 to SC6 are connected each other through a third common node. The other terminals of the switch elements SD1 to SD6 are connected each other through a fourth common node. The other terminals of the switch elements SE1 to SE6 are connected each other through a fifth common node. The other terminals of the switch elements SF1 to SF6 are connected each other through a sixth common node. In short, the test circuit 16 includes common nodes (first to sixth common nodes) that are different for every bit lines with equal precedence of each gradation data.

Further, connection states (ON/OFF) of these 36 switch elements are switched by the test input signal 6. For example, when the test input signal 6 is low level, each switch element is turned off. In this case, the test circuit 16 shows the operation of the normal operation mode. In short, in the normal operation mode, the test circuit 16 outputs the gradation data output from the gradation data latch circuit 15 directly to the level shifter 17.

On the other hand, when the test input signal 6 is high level, each switch element is turned on. In this case, the test circuit 16 shows the operation of the test mode. More specifically, the bit lines A1 to A6 are connected together. The bit lines B1 to B6 are connected together. The bit lines C1 to C6 are connected together. The bit lines D1 to D6 are connected together. The bit lines E1 to E6 are connected together. The bit lines F1 to F6 are connected together. Further, the bit lines with equal precedence of each gradation data output from the gradation data registers 14-1 to 14-6 (not shown) are controlled to have the same potential each other by the gradation data input signal 4. In short, the bit lines A1 to A6 are controlled to have the same potential. Likewise, the bit lines B1 to B6 have the same potential, the bit lines C1 to C6 have the same potential, the bit lines D1 to D6 have the same potential, the bit lines E1 to E6 have the same potential, and the bit lines F1 to F6 have the same potential. Note that, in the test mode, as described above, the bit lines with equal precedence of each gradation data are connected with each other.

When no bit line includes a defect (normal performance), which means when the gradation data is correctly transferred, the potentials of the bit lines that are connected together show the same value. Thus, in the normal performance, there is no potential difference between the bit lines, and the current does not flow. On the other hand, when any of the bit lines includes a defect, which means when the gradation data is not correctly transferred, the potential of the bit line having a defect has a different value. In short, only the bit line having a defect has a potential that is different from that of the bit lines connected together. In summary, when any of the bit lines includes a defect, there is generated a potential difference between the bit lines that are connected together, and the current flows. Note that this current value can be inspected by measuring the high potential side power supply 10 or the low potential side power supply 11 of the gradation data latch circuit 15 that is provided in the previous stage of the test circuit 16.

By employing such a circuit configuration, it is possible to readily observe the transfer defect of the gradation data using an inexpensive tester for measuring the power supply current. Further, in the first exemplary embodiment of the present invention, the voltage value of the output signal is not observed unlike the related art. Accordingly, there is no need to newly add the circuit for detecting a failure (observation circuit to observe the test result). Further, there is no need to provide a test output terminal for realizing it.

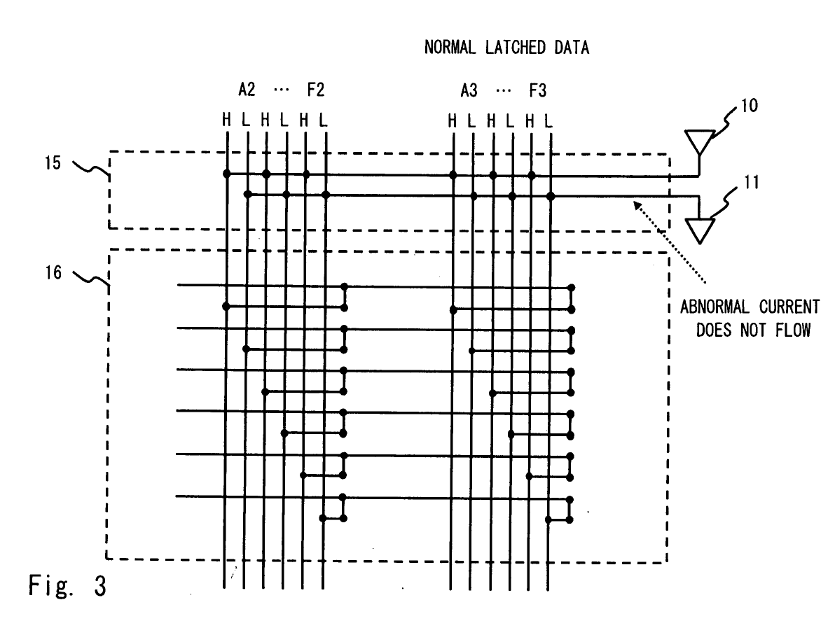

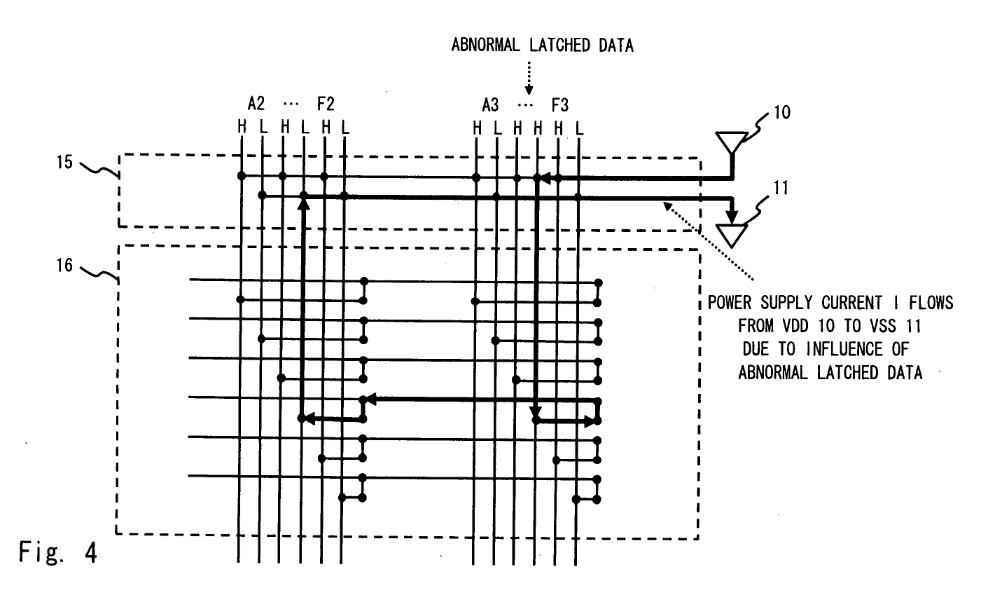

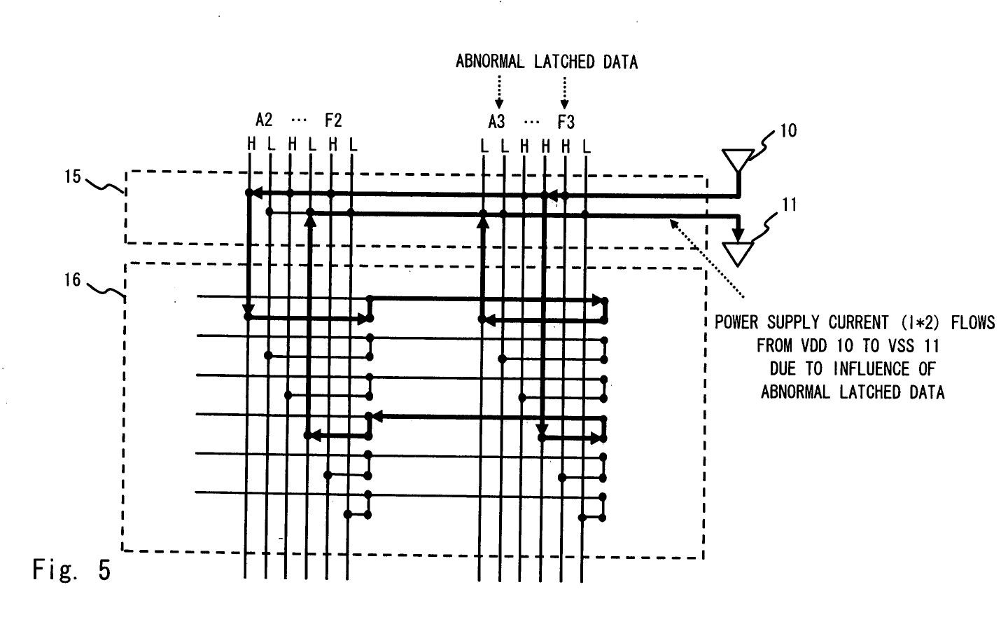

FIGS. 3 to 5 show specific examples of the test operation of the display driver according to the first exemplary embodiment of the present invention. FIGS. 3 to 5 all show the operation in the test mode. FIG. 3 shows an example of the operation when the gradation data is correctly transferred. FIG. 4 shows an example of the operation when a defect occurs in one bit line of the gradation data. FIG. 5 shows an example of the operation when a defect occurs in two bit lines of the gradation data. Further, the examples shown in FIGS. 3 to 5 all show only the circuit configuration of the gradation data latch circuit 15 and the test circuit 16. Further, in the examples shown in FIGS. 3 to 5, only the connection relation between the gradation data (A2, B2, C2, D2, E2, F2) output from the gradation data register 14-2 (not shown) and the gradation data (A3, B3, C3, D3, E3, F3) output from the gradation data register 14-3 (not shown) is shown.

As described above, FIGS. 3 to 5 all show the operation in the test mode. Accordingly, the bit lines A2 and A3 are connected together in the test circuit 16. The bit lines B2, B3 are connected together. The bit lines C2, C3 are connected together. The bit lines D2, D3 are connected together. The bit lines E2, E3 are connected together. The bit lines F2, F3 are connected together. Further, the bit lines with equal precedence of each gradation data output from the gradation data registers 14-1 to 14-6 are controlled to have the same potential in the normal state. In the example shown in FIG. 3, high-level voltage is supplied to the bit lines A2, A3. Low-level voltage is supplied to the bit lines B2, B3. High-level voltage is supplied to the bit lines C2, C3. Low-level voltage is supplied to the bit lines D2, D3. High-level voltage is supplied to the bit lines E2, E3. Low-level voltage is supplied to the bit lines F2, F3.

Now, each gradation data is output from the gradation data latch circuit 15. In short, the bit lines having high voltage level are connected to the high potential side power supply terminal 10. Further, the bit lines having low voltage level are connected to the low potential side power supply terminal 11.

The normal performance will be described first. In this case, as shown in FIG. 3, the potentials of the bit lines that are connected together have the same value. In short, there is produced no potential difference between the bit lines that are connected together. Thus, there is no abnormal current flowing in the high potential side power supply 10 or the low potential side power supply 11 through each bit line.

Next, description will be made on a case in which a defect occurs in the bit line D3. In this case, as shown in FIG. 4, the voltage level of the bit line D3 becomes high, which is different from the original level. At this time, there is produced a potential difference between the bit lines D2 and D3. Thus, as shown in a path shown by a solid line with an arrow in FIG. 4, the abnormal current I flows from the high potential side power supply 10 to the low potential side power supply 11 through the bit lines D3 and D2. In short, it is possible to observe the transfer defect of the gradation data by measuring the power supply current.

Next, description will be made on a case in which a defect further occurs in the bit line A3. In this case, as shown in FIG. 5, the voltage level of the bit line A3 becomes low, which is different from the original level. At this time, there are produced potential differences between the bit lines D2 and D3, and between the bit lines A2 and A3. Thus, as shown in a path shown by a solid line with an arrow in FIG. 5, the abnormal current I flows from the high potential side power supply 10 to the low potential side power supply 11 through the bit lines D3 and D2. Similarly, the abnormal current I flows from the high potential side power supply 10 to the low potential side power supply 11 through the bit lines A2 and A3. In summary, the abnormal current I*2 flows from the high potential side power supply 10 to the low potential side power supply 11. From the above description, it is possible to inspect how many transfer defects of the gradation data are occurred by measuring the abnormal current that flows from the high potential side power supply 10 to the low potential side power supply 11.

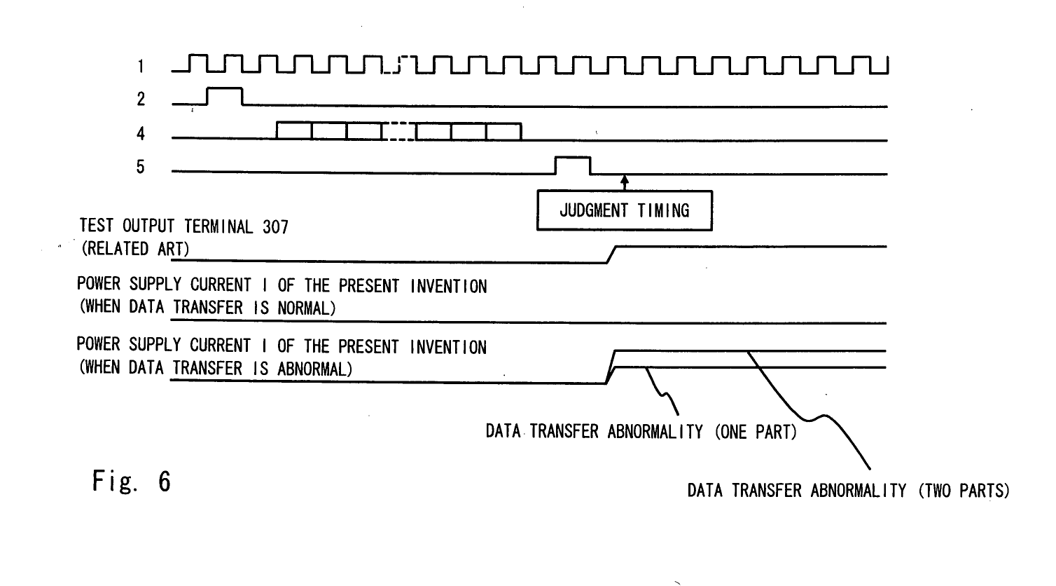

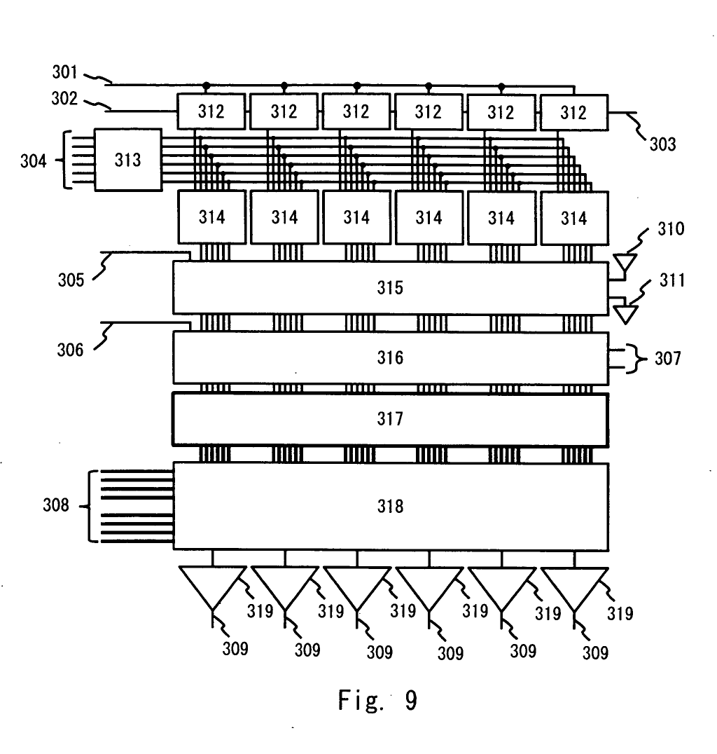

FIG. 6 is a timing chart showing the test operation of the display driver according to the first exemplary embodiment of the present invention. Further, in FIG. 6, a comparison is made between the test operation according to the related art and that according to the first exemplary embodiment of the present invention. In summary, FIG. 6 shows a timing chart of a case in which the voltage of the test output signal 307 according to the related art shown in FIG. 9 is observed and a case in which the power supply current (the high potential side power supply 10, the low potential side power supply 11) according to the first exemplary embodiment of the present invention are measured.

In the example shown in FIG. 6, the shift register 12 detects the start pulse input signal 2 in synchronization with a falling edge of the clock signal 1 and outputs the shift pulse signal. Then, the gradation data registers 14-1 to 14-6 store the gradation data input signal 4 based on the shift pulse signal. After that, the gradation data stored in the gradation data registers 14-1 to 14-6 is concurrently output from the gradation data latch circuit 15. Although description has been made in the example shown in FIG. 6 of the example of operating the circuit in synchronization with the falling edge of the clock signal 1, it is not limited to this example. For example, the present invention can also be applied to a case in which the circuit is operated in synchronization with a rising edge of the clock signal 1.

In the related art shown in FIG. 9, the operation test is performed by detecting the voltage level (high level or low level) of the signal output from the test output terminal 307. However, even when there are two defective parts, it is impossible to detect it. Meanwhile, according to the first exemplary embodiment of the present invention, the operation test is performed by measuring the value of the power supply current flowing in the high potential side power supply 10 or the low potential side power supply 11. The abnormal current does not flow in the normal performance. On the other hand, when the data transfer is abnormal, the current value according to the number of bit lines having defects is measured. In the example shown in FIG. 6, the abnormal current that flows when there are two defective parts is twice as much as the abnormal current that flows when there is one defective part. Hence, by measuring the abnormal current that flows from the high potential side power supply 10 to the low potential side power supply 11, it is possible to inspect how many transfer detects of the gradation data occur.

Although description has been made in the first exemplary embodiment of the present invention of the case in which the bit lines with equal precedence of each gradation data output from the gradation data registers 14-1 to 14-6 have the same potential, it is not limited to this example. For example, among the bit lines with equal precedence, any of the bit lines may be set to the potential that is different from the potential of other bit lines. Hence, in the normal performance, the current I flows from the high potential side power supply 10 to the low potential side power supply 11. On the other hand, when there is a defect in the bit line having the different potential, current that is different from the current I flows. By performing the similar processing on the other bit lines as well, it is possible to specify on which bit line the defect occurs.

### Second Exemplary Embodiment

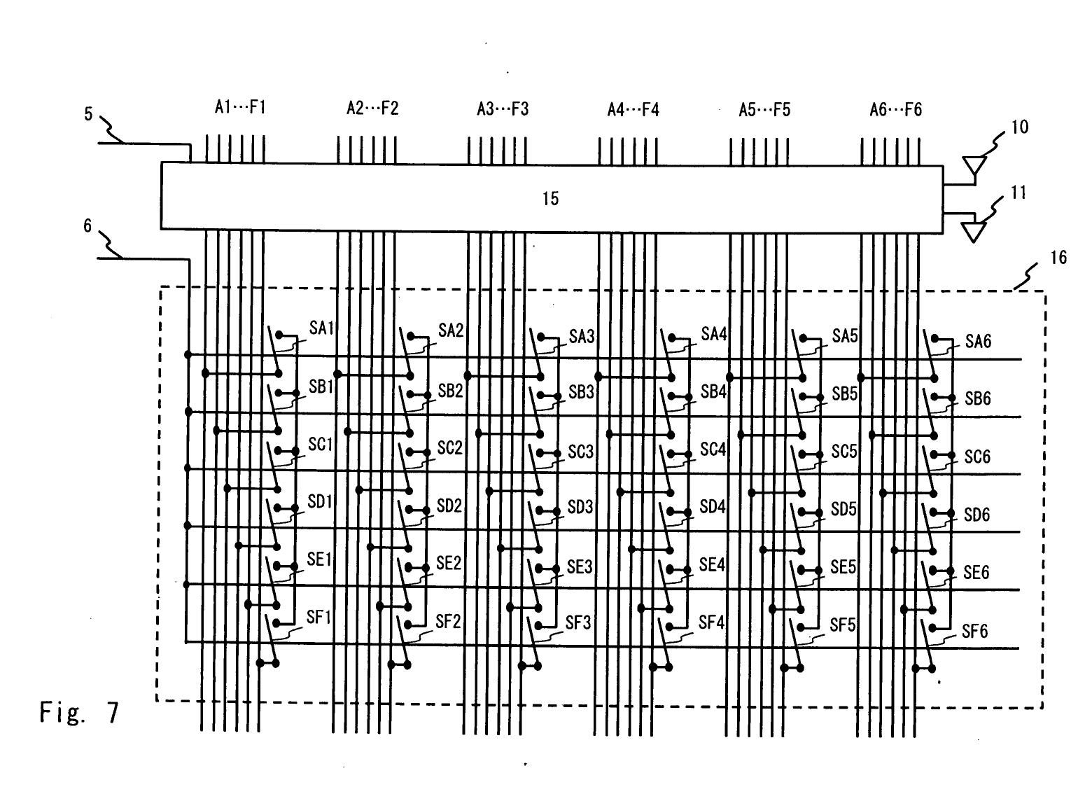

FIG. 7 shows the circuit configuration of the test circuit 16 included in a display driver according to the second exemplary embodiment of the present invention. In the circuit shown in FIG. 7, the connection relation of the switch elements provided in the test circuit 16 is different from that of the first exemplary embodiment of the present invention shown in FIG. 7.

In the example shown in FIG. 7, one terminal of each of the 36 switch elements provided in the test circuit 16 is connected to each corresponding bit line. The other terminals of the switch elements SA1, SB1, SC1, SD1, SE1, SF1 are connected each other through the first common node. The other terminals of the switch elements SA2, SB2, SC2, SD2, SE2, SF2 are connected each other through the second common node. The other terminals of the switch elements SA3, SB3, SC3, SD3, SE3, SF3 are connected each other through the third common node. The other terminals of the switch elements SA4, SB4, SC4, SD4, SE4, SF4 are connected each other through the fourth common node. The other terminals of the switch elements SA5, SB5, SC5, SD5, SE5, SF5 are connected each other through the fifth common node. The other terminals of the switch elements SA6, SB6, SC6, SD6, SE6, SF6 are connected each other through the sixth common node. In summary, the test circuit 16 includes common nodes (first to sixth common nodes) that are different for every plurality of bit lines showing single gradation data.

The connection states (ON/OFF) of the 36 switch elements are switched by the test input signal 6. For example, when the test input signal 6 is low level, the connection state of each of the switch elements is made OFF. In such a case, the test circuit 16 shows the operation of the normal operation mode. In short, in the normal operation mode, the test circuit 16 outputs the gradation data output from the gradation data latch circuit 15 directly to the level shifter 17.

On the other hand, when the test input signal 6 is high level, the connection state of each of the switch elements is made ON. In such a case, the test circuit 16 shows the operation of the test mode. More specifically, the bit lines A1, B1, C1, D1, E1, F1 are connected each other. The bit lines A2, B2, C2, D2, E2, F2 are connected each other. The bit lines A3, B3, C3, D3, 3, F3 are connected each other. The bit lines A4, B4, C4, D4, E4, F4 are connected each other. The bit lines A5, B5, C5, D5, E5, F5 are connected each other. The bit lines A6, B6, C6, D6, E6, F6 are connected each other. Further, among the gradation data output from the gradation data registers 14-1 to 14-6 (not shown), the plurality of bit lines showing single gradation data are controlled to have the same potential by the gradation data input signal 4. Specifically, for example, the bit lines A1, B1, C1, D1, E1, F1 output from the gradation data register 14-1 are controlled to have the same potential (high level, for example). Similarly, the bit lines A2, B2, C2, D2, E2, F2 are controlled to have the same potential, the bit lines A3, B3, C3, D3, E3, F3 are controlled to have the same potential, the bit lines A4, B4, C4, D4, E4, F4 are controlled to have the same potential, the bit lines A5, B5, C5, D5, E5, F5 are controlled to have the same potential, and the bit lines A6, B6, C6, D6, E6, F6 are controlled to have the same potential. As described above, in the test mode, the plurality of bit lines showing the single gradation data are connected together.

At this time, when no defect is found in all of the bit lines (normal performance), which means when the gradation data is correctly transferred, the plurality of bit lines that show the single gradation data have the same potential. Hence, in the normal performance, there is produced no potential difference between the bit lines, and the current does not flow. On the other hand, when a defect occurs in any of the bit lines, which means when the gradation data is not correctly transferred, the potential of the bit line having the defect shows a different value. In short, among the potentials of the bit lines that are connected each other, only the potential of the bit line having a defect has a different value. Hence, when there is a defect in any of the bit lines, there is produced a potential difference between the bit line where the defect occurs and the other bit lines that are connected thereto, and the current flows. Note that this current value can be inspected by measuring the high potential side power supply 10 or the low potential side power supply 11 of the gradation data latch circuit 15 provided in the previous stage of the test circuit 16. Further, also in the second exemplary embodiment, as is similar to the case in the first exemplary embodiment, it is possible to inspect how many transfer defects of the gradation data is occurred.

As stated above, also in the second exemplary embodiment, the transfer defect of the gradation data can be observed using the inexpensive tester for measuring the power supply current. Further, it is possible to inspect how many transfer defects of the gradation data are occurred. Further, in the second exemplary embodiment of the present invention, the voltage of the output signal is not observed unlike the related art. Thus, there is no need to newly add the circuit for detecting the failure (observation circuit to observe the test result). Further, there is no need to provide the test output terminal to realize this.

Although description has been made in the second exemplary embodiment of the present invention of the case in which the plurality of bit lines showing the single gradation data have the same potential among the gradation data output from the gradation data registers 14-1 to 14-6, it is not limited to this example. For example, it is also possible to set any of the bit lines among the plurality of bit lines showing the single gradation data to have a potential that is different from that of the other bit lines. Hence, in the normal performance, the current I flows from the high potential side power supply 10 to the low potential side power supply 11. On the other hand, when there is a defect in the bit line having different potential, current that is different from the current I flows. By performing the similar processing for other bit lines as well, it is possible to specify on which bit line the defect occurs.

Note that the present invention is not limited to the above exemplary embodiments, but can be changed as appropriate without departing from the spirit of the present invention. For example, the present invention is not limited to the circuit configuration of the display driver described above, but the circuit configuration without the output amplifier 19 may be possible if desired. Alternatively, the circuit configuration having a logic operation circuit may be possible, for example.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A display driver comprising:
a gradation data register that stores gradation data having a bit width; and
a gradation voltage signal generator that generates a gradation voltage signal that has voltage according to the gradation data stored in the gradation data register and outputs the generated gradation voltage signal, the display driver further comprising:
a test circuit that is provided between the gradation data register and the gradation voltage signal generator, the test circuit connecting at least a plurality of bit lines among bit lines provided between both of the circuits through a common node in a test mode, so as to perform failure detection based on a value of current that flows in the common node.

2. The display driver according to claim 1, wherein the test circuit comprises common nodes that are different for every bit lines with equal precedence of each gradation data among the bit lines.

3. The display driver according to claim 1, wherein the test circuit comprises common nodes that are different for every plurality of bit lines that show single gradation data.

4. The display driver according to claim 1, wherein the test circuit comprises switch elements between the common nodes and corresponding bit lines, and
the switch elements are turned on in the test mode and are turned off in a normal operation mode.

5. A method of testing a display driver that generates a gradation voltage signal according to gradation data having a bit width and outputs the generated gradation voltage signal, the method comprising:
connecting at least a plurality of bit lines among bit lines where the gradation data flows, the plurality of bit lines being connected through a common node; and
upon inputting gradation data for testing to the display driver, detecting whether a current value according to the gradation data for testing flows in the common node, so as to detect a failure.

6. The method of testing the display driver according to claim 5, comprising inputting the gradation data so that the plurality of bit lines connected to the common node have the same potential, so as to detect the failure in the plurality of bit lines based on a value of current that flows in the common node.

7. The method of testing the display driver according to claim 5, comprising inputting the gradation data so that any of the plurality of bit lines connected to the common node has a different potential, so as to detect the failure in the bit line that is set to have the different potential based on a value of current that flows in the common node.

8. The method of testing the display driver according to claim 5, comprising turning on switch elements in a test mode and turning off the switch elements in a normal operation mode, each of the switch elements provided between the common node and a corresponding bit line.
